(19) United States
(12) Patent Application Publication
(10) Pub. No.: US 2014/0065280 A1
(43) Pub. Date: Mar. 6, 2014

(54) Method for Treating a Starchy Food

(71) Applicants: Béatrice Conde-Petit, Zürich (CH); Markus Nussbaumer, Kirchberg (CH)

(72) Inventors: Béatrice Conde-Petit, Zürich (CH); Markus Nussbaumer, Kirchberg (CH)

(73) Assignee: Buhler AG, Uzwil (CH)

(21) Appl. No.: 14/111,949

(22) PCT Filed: Apr. 16, 2012
(86) PCT No.: PCT/EP2012/056937

§ 371 Date: Nov. 5, 2013

(30) Foreign Application Priority Data
Apr. 15, 2011 (EP) 11162741.0

(51) Int. Cl. A23L 1/212

(52) U.S. Cl. CPC A23L 1/2121
USPC 426/578; 426/465

(57) ABSTRACT

A starchy food having an initial moisture content in the range from 20% wb to 35% wb. is passed through states in which the food surface has various pairs temperature and surface moisture values. Then, the starchy food is brought to and maintained at a temperature in such a manner that a degree of gelatinization of at least 75% is achieved. Then, the surface is cooled to a temperature below the temperature T_{g mid} of the glass transition curve, based on the moisture of the starchy food. Then, the cooled, starchy food is dried at a temperature above the temperature T_{g onset} of the glass transition curve, based on the moisture of the starchy food.

The invention relates to a method for treating a starchy food and a rapidly cookable starchy food as claimed in the preambles to the independent claims.

Starchy foods and in particular semolina and/or flour from this are a staple food in many parts of the world, which are often used for the production of a prepared food. For example, a food is often prepared from maize semolina or else maize flour by cooking.

However, this has the disadvantage of a long cooking time of over 25 mins, which for many consumers is no longer acceptable nowadays.

Furthermore, the production of a faster-cooking starchy food by cooking extrusion in a double-screw extruder or by rotary drying is known (T F Schweizer et al., Journal of Cereal Science 4 (1986) 193-203 and P. Colonna et al., Cereal Chem. 61(6): 538-543).

However, these methods have the disadvantage that at least as regards texture and consistency, such as for example the viscosity of the cooked product, the starchy food thereby prepared does not correspond to those prepared from traditional, not further treated, starchy foods.

Hence one purpose of the present invention is to avoid the disadvantages of the known method and in particular to provide a method for treating starchy foods and a rapidly cookable starchy food, to achieve a short cooking time with at the same time as good as possible conformity as regards texture and consistency compared to traditional products.

This problem is solved according to the invention with the method and the rapidly cookable starchy food as claimed in the independent patent claims.

The method according to the invention for treating a starchy food comprises a step of providing a starchy food with an initial moisture content in the range from 20% wb to 35% wb. The initial moisture content preferably lies in the range from 21% wb to 30% wb and particularly preferably from 22% wb to 25% wb. The method is used in particular for cereals and pseudocereals and any combinations thereof. During the process, the starchy food passes through states on the surface which exhibit various value pairs of temperature of the surface and moisture content of the surface.

This is followed by temperature equalization of the starchy food, so that a degree of gelatinization of at least 75% is attained. Preferably, a gelatinization level of at least 80% and particularly preferably in the range from 85% to 99% is attained. In particular, the temperature equalization is performed at a temperature T above the temperature T_{g end} of the glass transition curve based on the moisture content of the starchy food.

After this, cooling of at least a part of the surface of the temperature-equalized, starchy food is effected to a temperature T which lies below the temperature T_{g mean} of the glass transition curve based on the moisture content of the starchy food. In particular, cooling of the whole surface is effected. The cooling is effected for a duration in the range from 1 min to 4 mins, in particular from 1 min to 2 mins.

Next, drying of the cooled starchy food is effected at a temperature T which lies above the temperature T_{g onset} of the glass transition curve based on the moisture content of the starchy food. Preferably the temperature T lies between the temperature T_{g onset} and the temperature T_{g end}. In particular, the drying is effected to a final moisture content in the range from 10% wb to 14% wb, preferably from 10% wb to 12% wb.

In the sense of the present application, a moisture content of for example “20% wb” is understood to mean a moisture content in weight percent based on the wet weight (wet basis).

In the sense of the present application, “cereals” are understood to mean cultivated plants of the botanical family of the true grasses; in particular, wheat, rye, oat, barley, rice, millet and maize are cereals in the sense of the present application.

In the sense of the present application, “pseudo-cereals” are understood to mean cereal-like granular fruit which however botanically speaking are not grasses. In contrast to cereals, they contain no gluten. Inter alia, buckwheat, amaranth and quinoa are pseudocereals in the sense of the present application.

The determination of the degree of gelatinization, i.e. the degree of agglutination, is effected by DSC (“Differential Scanning calorimetry”) measurements known to those skilled in the art. For this, the gelatinized sample is milled to a particle size smaller than 200 μm and mixed with water to a moisture content of 65% wb. Next, the product is heated in the DSC device from 10° C. to 100° C. at a rate of 10° C. per minute and the enthalpy of fusion in the range between 55 and 85° C. evaluated and compared with the enthalpy of fusion of the raw, i.e. non-gelatinized, product.

In the sense of the present application, the term “particle size” of a particle is understood to mean the greatest longitudinal dimension of the particle.

The determination of the glass transition curve of a starchy food is effected by means of a rheological measurement, such as for example with the “phase transition analyzer” according to the method described in the publication by Brian Plattner et al. (The Society for engineering in agricultural, food and biological systems, Paper number: 01-6067, An ASEA Meeting Presentation The Phase Transition Analyzer and its Impact on Extrusion Processing of Foodstuffs). In this, the whole food (thus for example the maize flour) is analyzed. According to this method, a glass transition curve is determined which determines a first pair (U1, T_{g onset}) and a second pair (U1, T_{g end}) of moisture content and temperature each time for a defined moisture content U1. These two temperatures define a glass transition range at the moisture content U1. A third temperature, lying between these, is the arithmetical mean value for the pair (U1, T_{g mean}).

For a temperature-moisture pair (U1, T) of a starchy food based on the temperature-moisture pair (U1, T_{g end}), the food is in a gummy state if T>T_{g end}. For a temperature-moisture pair (U1, T) of a starchy food based on the temperature-moisture pair (U1, T_{g} onset), the food is in a glassy state if T<T_{g onset}. For a temperature-moisture pair (U1, T) of a starchy food based on the temperature-moisture pair (U1, T_{g onset}) and (U1, T_{g end}), the food is in a partly glassy and partly gummy state if T_{g onset}≦T≦T_{g end}.

The method according to the invention now has the advantage that during the cooling step the starchy food is in particular already dried, but above all is at least partly converted into a glassy state (and as far as possible kept therein during the further drying). Although the phenomena occurring have not been finally explained, it is at present supposed that the water is driven out from the rigid, glassy lattice and leaves behind voids which results in improved water uptake capability (“hydratability”) for example during subsequent cooking of the dried starchy food; this in turn leads to a texture and consistency of the food which is very similar to traditional products, which is desired by the consumer. Also, in spite of final drying at higher temperatures following the first cooling, hardening and sealing of the surface (so-called “case hardening”) can be avoided.

In addition, the method has the further advantage that the cooling acts similarly to so-called freeze-drying, without however having to cool the food below the freezing point of water at ambient pressure, which accelerates the drying and decreases the power consumption.

Preferably, during the temperature equalization the starchy food has the temperature T above the temperature T_{g end} at least for 80% and preferably for at least 90% of the duration.

In particular, the starchy food is temperature-equalized for a duration from 15 mins to 120 mins, preferably from 50 mins to 70 mins.

According to experience, brief deviations below the temperature T_{g end} have no adverse effects on the temperature equalization process or the subsequent process steps.

Particularly preferably, the temperature equalization of the starchy food is effected at a temperature T between 70 and 120° C., preferably between 80 and 100° C. and particularly preferably between 90 and 95° C.

This has the advantage that the desired degree of gelatinization is reached with simultaneous substantial maintenance of the nutrients in the temperature-equalized, starchy food, which are not degraded by excessively high temperatures.

Quite especially preferably, during the drying the cooled starchy food at least for 80% and preferably for at least 90% of the duration has the temperature T above the temperature T_{g onset}.

According to experience, brief deviations below the temperature T_{g onset} have no adverse effects on the drying process or the subsequent process steps.

Herein in each case the “duration” is understood to mean the time needed until attainment of the desired final moisture content.

Preferably, the temperature-equalized starchy food is flaked and/or sieved before the cooling, in particular flaked to a thickness in the range from 0.25 mm to 1.50 mm, preferably from 0.4 mm to 0.6 mm.

Here, “thickness” is understood to mean the smallest longitudinal dimension of the particle.

From here on and below, “flaking” is understood to mean crushing, for example with a cylinder mill, for the formation of flake-shaped particles.

In addition, the flaking has the advantage that the ratio of surface to volume of the flakes is increased, so that the subsequent cooling and/or drying can take place more efficiently.

Particularly preferably, the step of providing the starchy food includes a conditioning to the desired initial moisture content.

Herein, “conditioning” is understood to mean the as uniform as possible establishment of a defined moisture content.

Quite especially preferably, before providing the starchy food is treated by means of at least one of the following methods or any combinations thereof: cleaning, husking, degerming and milling.

This has the advantage that undesired components such as husks, impurities or even environmental toxins are removable from the starchy food before the further processing. In addition, a defined particle size or particle size distribution can advantageously be established by milling, so that at least the temperature equalization step can be performed efficiently.

Preferably, at least one additive, in particular at least one emulsifier, one enzyme or any combinations thereof are mixed with the starchy food before the temperature equalization. Possible emulsifiers are in particular lecithin, mono- and diglycerides and food-compatible derivatives of the mono- and diglycerides. Suitable enzymes are xylanases, hemicellulases, amylases, lipases, proteases or transglutaminases.

This has the advantage that the properties of the starchy food can be adapted to the corresponding treatment method.

As additives, for example emulsifiers are suitable for the adjustment of various properties such as the viscosity, glutinousness, gel formation or also the degradability of enzymes. In particular, emulsifiers are admixed in a proportion of 0.25% to 1% based on the starchy food.

Particularly preferably, at least one nutrient, one protein, starch or any combinations thereof are mixed into the dried starchy food.

In particular, starch can be admixed in a proportion in the range from 2% to 5% based on the starchy food. In particular, protein-containing flours such as for example from soya or also enriched flours from pulses can be admixed in a proportion in the range from 6% to 12% based on the starchy food.

This has the advantage that additional nutrients such as for example vitamins or minerals can be mixed into the final product if needed.

The admixture of starch has the advantage that inter alia the viscosity and/or the texture of the product can be adapted to desired properties.

The admixture of protein-containing flours such as for example from soya or also enriched flours from pulses has the advantage that the nutritional value is adjustable.

Quite particularly preferably, the dried starchy food is milled to semolina and/or flour and optionally sieved, in particular to establish a mean size distribution of the particles, preferably a mean size of greater than 200 μm, particularly preferably in the range from 400 μm to 500 μm.

This has the advantage that the particle size distribution can be adjusted depending on the purpose of the further processing of the dried starchy food.

The “mean size distribution” is understood to mean the mean value of the particle sizes.

A further aspect of the present invention is directed at a rapidly cookable starchy food which is producible and in particular is produced by a method as above.

A still further aspect of the present invention is directed at a rapidly cookable starchy food as described above with a cooking time of less than 4 mins for attainment of a gel stability index greater than 100 g, preferably greater than 150 g, particularly preferably greater than 200 g and quite especially preferably greater than 250 g. The cooking time is preferably less than 2 mins.

The determination of the gel stability index of the rapidly cookable starchy food is effected as follows: mixing of 20 g of a starchy food with a moisture content of 10% wb with 180 ml of boiling water for a cooking time of two minutes; excess water is not removed, since the quantity used is completely absorbed. Next, the paste thereby resulting is filled into a cylinder with a diameter of 3 cm and a height of 2 cm, the cylinder being completely filled thereby. Next, the cylinder is closed and stored at ca. 5° C. for 20 to 24 hours. For the measurement, the paste is temperature-equalized to a temperature of 10° C.±2° C. The gelled paste is then removed from the cylinder and compressed by means of a piston with a diameter of 5 cm, during which the piston is moved with a speed of 1 mm/sec. The force for compression of the paste by 6.25 mm and by 7 mm along the cylinder axis is measured in grams, and the compression is ended at 7 mm and maintained. The compression by 6.25 mm corresponds to a force F1 in grams and the compression by 7 mm to a force F2 in grams. After attainment of the compression by 7 mm, the force for achieving this compression is again measured after 30 seconds, which corresponds to a force F3.

In contrast, the gel stability index for traditional maize semolina or else traditional maize flour is measured with a cooking time of 30 mins, the further steps for the determination of the gel stability index being identical to the steps described above.

A strength F is defined as follows: F=F1 in g. An elasticity is defined as follows: E=F3/F2*100 in %. The gel stability index is defined as follows: G=F*E/100 in g.

The attainment of the gel stability index of at least greater than 100 g has the advantage that the rapidly cookable starchy food has a similar consistency to a traditionally produced product, which however has to be cooked for 30 mins.

Traditional maize semolina or else traditional maize flour for example has a gel stability index of 280 g after a cooking time of 30 mins. The gel stability index of the rapidly cookable starchy food according to the invention, which was produced from the same maize, has a similar gel stability index of 282 g, in particular at a mean size distribution of the particles in the range from 400 μm to 500 μm. In contrast to this, a rapidly cookable starchy food produced by extrusion methods from the state of the art only has a gel stability index of 25 g after a cooking time of two minutes.

The food preferably has a viscosity of greater than 3200 cPoise, preferably greater than 6000 cPoise and particularly preferably greater than 8000 cPoise, in particular with a mean size distribution of the particles in the range from 400 μm to 500 μm.

This final viscosity of at least 3200 cPoise has the advantage that the consistency and texture for the consumer essentially corresponds to the traditional product.

The determination of the viscosity is effected as follows by means of a Rapid Viscoanalyzer (RVA) from the company Newport Scientific: 3.5 g of maize flour with a moisture content of 12% wb are mixed with 25 ml water at a temperature of 25° C. in the RVA vessel. Next, the mixture is heated to 95° C. within 5 mins and held at this temperature for 3 mins. Next the mixture is cooled to 25° C. within 5 mins. The final viscosity here corresponds to the viscosity measured at the end after the cooling.

A further aspect of the present invention is directed at the use of a rapidly cookable starchy food as described above for the production of a packed food product.

For better understanding, the invention is explained in more detail below on the basis of practical examples.

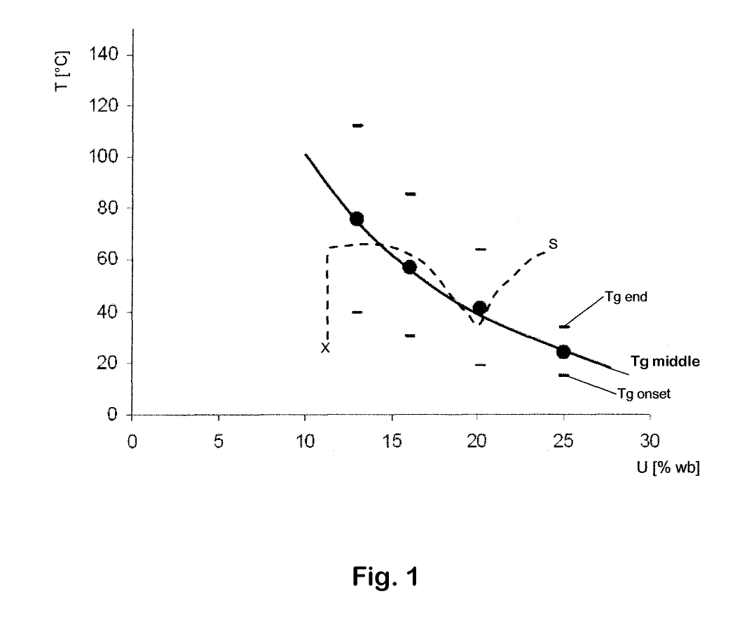

FIG. 1: shows the temperature/moisture diagram of states which are passed through in the method according to the invention;

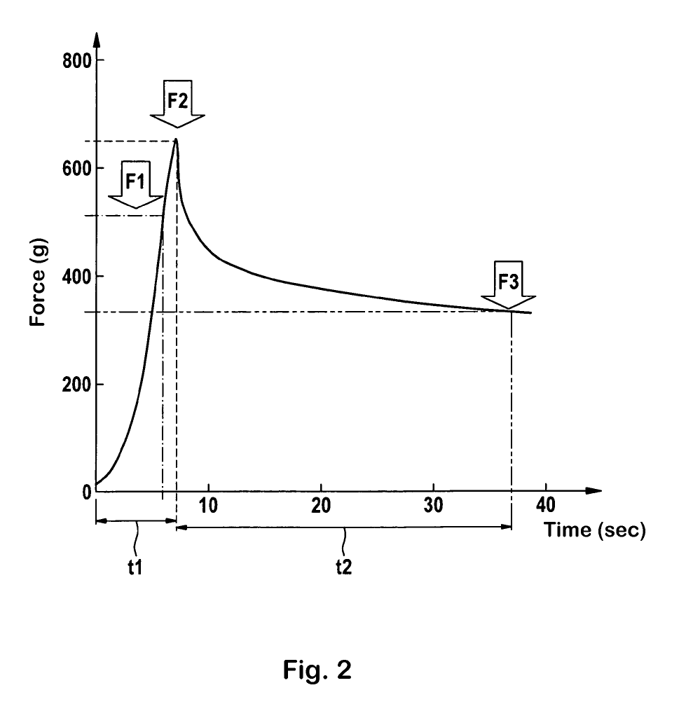

FIG. 2: shows an illustration for the determination of the forces F1, F2 and F3, which are used for the determination of the strength, elasticity and the gel stability index;

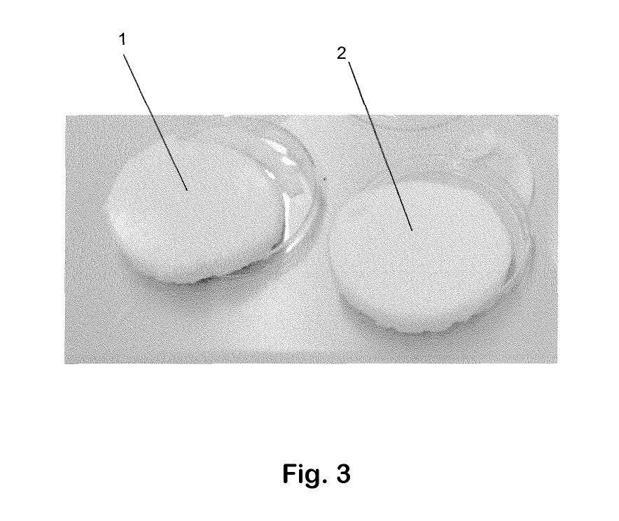

FIG. 3: shows a comparison of the external appearance of traditionally cooked maize semolina (on left) and a cooked food product according to the invention;

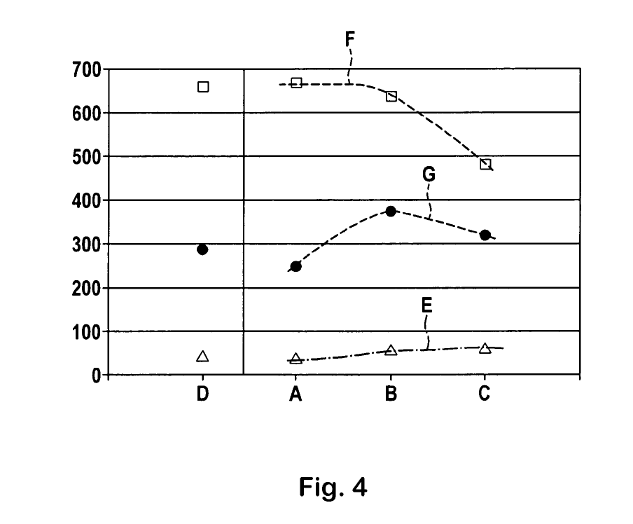

FIG. 4 shows gel properties and viscosity of cooked food products according to the invention, depending on the particle size; and

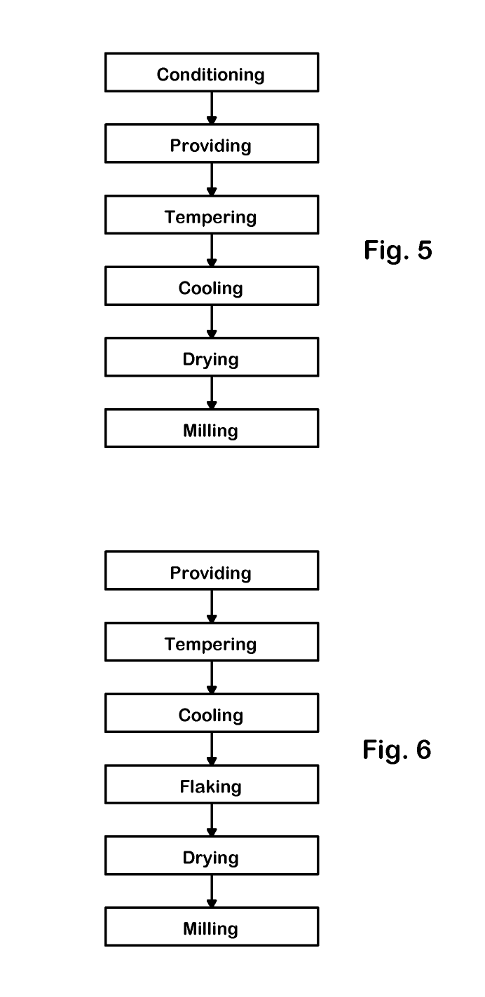

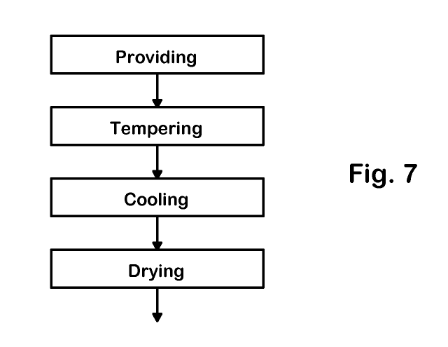

FIGS. 5-7: show flow diagrams of different variants of the method according to the invention.

In FIG. 1, a temperature/moisture diagram of states which are passed through in the method according to the invention is shown. The temperature of the food in ° C. is plotted on the y axis and the moisture content in wt. % on the x axis (based on the wet mass, i.e. wet-base “wb”). The glass transition temperatures T_{g onset} and T_{g end} are determined according to the method described by Brian Plattner et al. (The Society for engineering in agricultural, food and biological systems, Paper number: 01-6067, An ASEA Meeting Presentation: The Phase Transition Analyzer and its Impact on Extrusion Processing of Foodstuffs); here T_{g onset} corresponds to the value described by Plattner et al. as T_{g initial}. For a defined moisture content U, a first pair (U, T_{g onset}) and a second pair (U, T_{g end}) of moisture content and temperature is determined each time, wherein the value pairs respectively define the starting and the end point of the glass transition range. Repetition of the determination at other moisture contents U yields a glass transition range in the graph shown in FIG. 1, which lies between the curves T_{g onset} and T_{g end} (not traced). A third temperature/moisture curve, lying between these two curves is the mean value of T_{g onset} and T_{g end}, i.e. T_{g mean}.

The practical example relates to maize, which is temperature-equalized at a temperature which lies above the curve T_{g end} (here at >60° C.), represented by the symbol S (start point). This is followed by cooling (here with simultaneous drying, i.e. reduction of the moisture content U), at a temperature which lies below T_{g mean} (here about 35° C.). Next a further drying is effected, in which the temperature/moisture value pairs which as far as possible lie in the glass transition region which is defined by the intermediate region between T_{g onset} and T_{g end} are passed through. Here it is possible that the temperature/moisture value pairs lie above or also below T_{g mean}. It is clear that drying at lower temperature results in prolongation of the time needed, which would be needed for an otherwise comparable drying result. Hence, in practice a considerable part of the drying will take place in the range between T_{g mean} and T_{g end}, as a result of which a good compromise between profitability and acceptable product is achievable. As soon as the desired final moisture content is reached (or already shortly before this), the product is cooled: represented by the symbol X (end point).

In FIG. 2, the method used in the context of the invention for the determination of the measured values which are necessary for the calculation of the strength and elasticity and the gel stability index is illustrated. The paste as described above is compressed as already described, during which the piston is moved at a speed of 1 mm/sec. The force (in g) for the compression by a first distance is designated as F1. This first distance is 6.25 mm long. The force (in g) for compression by a second distance, which is longer than the first distance, is designated as F2. This second distance is 7 mm long. The time until attainment of this second compression is designated as t2. The compression is then ended at 7 mm and maintained. After the attainment of the compression by 7 mm, the force for achieving this compression is measured again after a further 30 seconds (t2), which corresponds to a force F3.

In FIG. 3, the properties of a cooked starchy food according to the invention, namely of cooked maize flour produced according to the invention (right, 2) in comparison to the traditional cooked maize flour (left, 1) are illustrated. The visual appearance and the texture are comparable. The following measured values were obtained:

### EXAMPLE 1

Gel properties of cooked, commercially obtainable maize flour after 30 minutes cooking time (sample 1):

| | | |
|---|---|---|
| a. | Strength (g): | 553 |
| b. | Elasticity (%): | 51 |
| c. | Gel stability index: | 280 |

Gel properties of cooked maize flour produced according to the invention after 2 minutes cooking time (boiled with 27.1% water (wb, after cooking) with maize flour according to sample 1 as starting material):

| | | |
|---|---|---|
| a. | Strength (g): | 660 |
| b. | Elasticity (%): | 43 |
| c. | Gel stability index: | 282 |

### EXAMPLE 2

Gel properties of cooked, commercially obtainable maize flour after 30 minutes cooking time (sample 2):

| | | |
|---|---|---|
| a. | Strength (g): | 443 |
| b. | Elasticity (%): | 44 |
| c. | Gel stability index: | 195 |

Gel properties of cooked, maize flour produced according to the invention after 2 minutes cooking time (boiled with 25.6% water (wb, after cooking) with maize flour according to sample 1 as starting material):

| | | |
|---|---|---|
| a. | Strength (g): | 653 |
| b. | Elasticity (%): | 39 |
| c. | Gel stability index: | 255 |

### Comparative Example

A faster cooking maize flour, which was produced by cooking extrusion in a double-screw extruder, as described in the introduction, was tested after two minutes cooking time:

| | | |
|---|---|---|
| a. | Strength (g): | 91 |
| b. | Elasticity (%): | 27 |
| c. | Gel stability index: | 25 |

It is clear that such products are far from being comparable with the products familiar from traditional products and expected by the consumer.

In FIG. 4, a strength F, an elasticity E and a gel stability index G of a cooked food product according to the invention are shown as functions of the particle size.

D represents the whole cooked food product. A mean particle size for D is not stated.

Mean particle sizes are stated on the x axis in the region of the points A, B and C.

A is a coarse fraction of the cooked food product with a mean particle size of greater than 400 μm.

B is a medium fraction of the cooked food product with a mean particle size in the range from 200 μm to 400 μm.

C is a fine fraction of the cooked food product with a mean particle size of less than 200 μm.

In FIGS. 5, 6 and 7, various flow diagrams are shown, which represent processes according to the invention. The process steps explained above and stated in the claims are correspondingly designated in the figures. It is clear that the step of providing a starchy food with a defined initial moisture content can make a preliminary conditioning necessary, as is shown in FIG. 5. Methods for conditioning (here: homogeneous moistening) of cereals and pseudocereals are immediately familiar to those skilled in the art. FIG. 6 illustrates an embodiment wherein no conditioning is necessary, since the starting material already has a suitable initial moisture content. In FIG. 5, it is indicated that a final milling can take place; suitable methods for the milling are of course familiar to those skilled in the art and require no further explanation here. Further, it is possible, as indicated in FIG. 6, to flake the products cooled according to the invention in a manner in itself known, for example in flaking roller mills; this can be effected before (as shown) or also (preferred) after the final drying. A final milling is also possible in such method variants. In FIG. 6, a flow diagram with the identical method steps as shown in claim 1 is shown.

1-15. (canceled)

16. A method for treating a starchy food, wherein the starchy food during the method passes through states on the surface which exhibit various value pairs of temperature (T) of the surface and moisture content (U) of the surface, comprising the following steps:
providing a starchy food with an initial moisture content in the range from 20% wb to 35% wb;
temperature equalization of the starchy food, so that a degree of gelatinization of at least 75%;
cooling of at least a part of the temperature-equalized, starchy food to a temperature T, which lies below the temperature Tg mean of the glass transition curve based on the moisture content (U) of the starchy food, for a duration in the range from 1 min to 4 mins;
drying of the cooled starchy food at a temperature T, which lies above the temperature Tg onset of the glass transition curve based on the moisture content (U) of the starchy food.

17. The method as claimed in claim 16, wherein during the temperature equalization the starchy food at least for 80% of the duration has the temperature T above the temperature Tg end.

18. The method as claimed in claim 16, wherein the temperature equalization of the starchy food is effected at least partially at a temperature T between 70 and 120° C.

19. The method as claimed in claim 16, wherein during the drying, the cooled starchy food at least for 80% of the duration has the temperature T above the temperature Tg onset.

20. The method as claimed in claim 16, wherein the drying of the cooled starchy food takes place at a temperature T of at most 80° C. above the temperature Tg onset of the glass transition curve based on the moisture content (U) of the starchy food.

21. The method as claimed in claim 16, wherein the temperature-equalized starchy food is flaked and/or sieved before the cooling.

22. The method as claimed in claim 16, wherein the step of providing the starchy food includes a conditioning to the desired initial moisture content.

23. The method as claimed in claim 16, wherein before providing the starchy food is treated by means of at least one of the following methods or any combinations thereof: cleaning, husking, degerming and milling.

24. The method as claimed in claim 16, wherein at least one additive is mixed into the starchy food before the temperature equalization.

25. The method as claimed in claim 16, wherein at least one nutrient, one protein, starch or any combinations thereof are mixed into the dried starchy food.

26. The method as claimed in claim 16, wherein the dried starchy food is milled to semolina and/or flour.

27. A rapidly cookable starchy food producible by means of a method as claimed in claim 16.

28. A rapidly cookable starchy food, wherein a cooking time of less than 4 mins and wherein a gel stability index greater than 100 g is attained.

29. The rapidly cookable starchy food as claimed in claim 28, with a final viscosity of greater than 3200 cPoise.

30. Use of a rapidly cookable starchy food as claimed in claim 27 for the production of a packed food product.
